(19) United States
(12) Patent Application Publication
(10) Pub. No.: US 2016/0277534 A1
(43) Pub. Date: Sep. 22, 2016

(54) RULES-BASED SEQUENTIAL MULTI-ROUTING OF DIAMETER REQUESTS

(71) Applicant: ALCATEL-LUCENT CANADA, INC., Ottawa (CA)

(72) Inventors: Robert A. Mann, Carp (CA); Peter K. Jorgensen, Nepean (CA); Mike Vihtari, Kanata (CA)

(21) Appl. No.: 14/661,040

(22) Filed: Mar. 18, 2015

(51) Int. Cl. H04L 29/08; H04L 1/16

(52) U.S. Cl. CPC H04L 67/327; H04L 1/1657

(57) ABSTRACT

Various exemplary embodiments relate to a method, network node, and non-transitory machine-readable storage medium encoded with instructions for execution by a network device, the non-transitory machine-readable storage medium including: instructions for associating a received response message with a previously-processed request message; instructions for evaluating operator-defined rules at run-time with respect to the received response message, the instructions for evaluating including: instructions for processing the previously-processed request as an outgoing request in response to encountering a first reference in an operator-defined rule.

### CROSS-REFERENCE TO RELATED APPLICATIONS

This application is related to the following co-pending applications, which are hereby incorporated herein by reference for all purposes: application Ser. No. 13/482,690, filed on May 29, 2012; application Ser. No. 13/482,897, filed on May 29, 2012; and application Ser. No. 13/602,579, filed on Sep. 4, 2012.

### TECHNICAL FIELD

Various exemplary embodiments disclosed herein relate generally to computer networking and, more specifically but not exclusively, to routing Diameter requests and answers in a long term evolution (LTE) carrier network.

### BACKGROUND

Since its proposal in Internet Engineering Task Force (IETF) Request for Comments (RFC) 3588, the Diameter protocol has been increasingly adopted by numerous networked applications. For example, the Third Generation Partnership Project (3GPP) has adopted Diameter for various policy and charging control (PCC), mobility management, and IP multimedia subsystem (IMS) applications. As IP-based networks replace circuit-switched networks, Diameter is even replacing SS7 as the key communications signaling protocol. As networks evolve, Diameter is becoming a widely used protocol among wireless and wireline communications networks.

One significant aspect of the Diameter protocol is Diameter packet routing. Entities referred to as Diameter routing agents (DRAs) facilitate movement of packets in a network. In various deployments, DRAs may perform elementary functions such as simple routing, proxying, and redirect.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a non-transitory machine-readable storage medium encoded with instructions for execution by a network device, the non-transitory machine-readable storage medium including: instructions for associating a received response message with a previously-processed request message; instructions for evaluating operator-defined rules at run-time with respect to the received response message, the instructions for evaluating including: instructions for processing the previously-processed request as an outgoing request in response to encountering a first reference in an operator-defined rule.

Various exemplary embodiments relate to a network device including: a network interface; a memory; and a processor in communication with the network interface and the memory, the processor being configured to: associate a received response message with a previously-processed request message; evaluate operator-defined rules at run-time with respect to the received response message, including: processing the previously-processed request as an outgoing request in response to encountering a first reference in an operator-defined rule.

Various exemplary embodiments relate to a method performed by a network device, the method including: receiving a response message; associating the response message with a previously-processed request message; evaluating at least one operator-defined response rule with respect to the received response message; and transmitting the previously-processed request message to another network device in response to encountering a first reference within the at least one operator-defined response rule.

Various embodiments are described wherein the first reference indicates that the previously-processed request should be retransmitted, and the instructions for processing the previously-processed request as an outgoing request include instructions for transmitting the previously-processed request to another device based on a current destination address of the previously-processed request.

Various embodiments are described wherein the first reference indicates that the previously-processed request should be reprocessed, and the instructions for processing the previously-processed request as an outgoing request include instructions for invoking an evaluation of at least one operator defined rule with respect to the previously-processed request.

Various embodiments are described wherein the instructions for evaluating operator-defined rules at run-time with respect to the received response message include instructions for modifying the contents of the previously-processed request message in response to encountering a second reference in an operator-defined rule.

Various embodiments additionally include instructions for evaluating operator-defined rules at run-time with respect to received request messages including: instructions for storing a value in association with the received request message in response to encountering a second reference in an operator-defined rule, whereby the instructions for associating a received response message with a previously-processed request message also retrieve values previously associated with the previously-processed request message.

Various embodiments are described wherein the instructions for storing a value in association with the received request message in response to encountering a second reference in an operator-defined rule include instructions for inserting the value into the received request message.

Various embodiments additionally include instructions for transmitting a received request message to at least one other device and without at least one value inserted into the received request by the instructions for inserting the value into the received request message.

### BRIEF DESCRIPTION OF THE DRAWINGS

In order to better understand various exemplary embodiments, reference is made to the accompanying drawings, wherein:

FIG. 1 illustrates an exemplary network environment for a Diameter Routing Agent;

FIG. 2 illustrates an exemplary Diameter Routing Agent;

FIG. 3 illustrates an exemplary hardware diagram for implementing a Diameter Routing Agent;

FIG. 4 illustrates an exemplary class diagram for defining various message context objects;

FIG. 5 illustrates an exemplary method for providing a “Property-Exists” function;

FIG. 6 illustrates an exemplary method for providing a property getter function;

FIG. 7 illustrates an exemplary method for providing a property setter function;

FIG. 8 illustrates an exemplary method for providing a resend function; and

FIG. 9 illustrates an exemplary method for providing a reprocess function.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated.

Diameter Routing Agents (DRAs) available today provide only basic functionalities typically defined in hard coding or scripting. As such, users may typically not be empowered to easily and flexibly define more complex behaviors for a DRA. In many situations, behavior similar to a redirect can be useful. For example, when routing a request to one of a collection of downstream servers, if an unsatisfactory response is returned (or no response is returned at all), it would be beneficial to allow a DRA to resend the original request to another destination from the collection of servers in an attempt to receive a satisfactory response, rather than leaving the client to take additional action to resend the request.

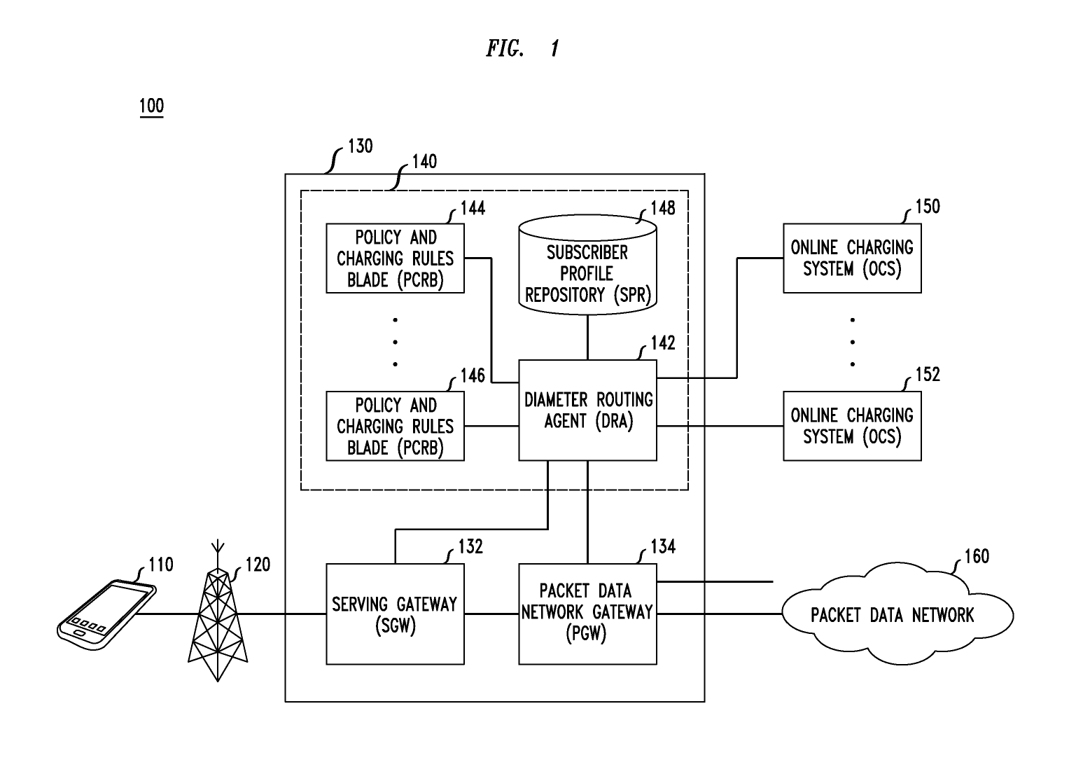

FIG. 1 illustrates an exemplary network environment 100 for a Diameter Routing Agent (DRA) 142. Exemplary network environment 100 may be a subscriber network for providing various services. In various embodiments, subscriber network 100 may be a public land mobile network (PLMN). Exemplary subscriber network 100 may be telecommunications network or other network for providing access to various services. Exemplary subscriber network 100 may include user equipment 110, base station 120, evolved packet core (EPC) 130, online charging systems (OCS) 150, 152, packet data network 160.

User equipment 110 may be a device that communicates with packet data network 160 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by the relevant 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the relevant 3GPP standards. EPC 130 may include a serving gateway (SGW) 132, a packet data network gateway (PGW) 134, and a session control device 140.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Session control device 140 may be a device that provides various management or other functions within the EPC 130. For example, session control device 140 may provide a Policy and Charging Rules Function (PCRF). In various embodiments, session control device 140 may include an Alcatel Lucent 5780 Dynamic Services Controller (DSC). Session control device 140 may include a DRA 142, a plurality of policy and charging rules blades (PCRBs) 144, 146, and a subscriber profile repository.

As will be described in greater detail below, DRA 142 may be an intelligent Diameter Routing Agent. As such, DRA 142 may receive, process, and transmit various Diameter messages. DRA 142 may include a number of user-defined rules that govern the behavior of DRA 142 with regard to the various Diameter messages DRA 142 may encounter. Based on such rules, the DRA 142 may operate as a relay agent, proxy agent, or redirect agent. For example, DRA 142 may relay received messages to an appropriate recipient device. Such routing may be performed with respect to incoming and outgoing messages, as well as messages that are internal to the session control device.

Policy and charging rules blades (PCRB) 144, 146 may each be a device or group of devices that receives requests for application services, generates PCC rules, and provides PCC rules to the PGW 134 or other PCENs (not shown). PCRBs 144, 146 may be in communication with an AF (not shown) via an Rx interface. PCRB 144, 146 may receive an application request in the form of an Authentication and Authorization Request (AAR) from an AF. Upon receipt of an AAR, PCRB 144, 146 may generate at least one new PCC rule for fulfilling the application request.

PCRB 144, 146 may also be in communication with SGW 132 and PGW 134 via a Gxx and a Gx interface, respectively. PCRB 144, 146 may receive an application request in the form of a credit control request (CCR) from SGW 132 or PGW 134. As with an AAR, upon receipt of a CCR, PCRB 144, 146 may generate at least one new PCC rule for fulfilling the application request. In various embodiments, the AAR and the CCR may represent two independent application requests to be processed separately, while in other embodiments, the AAR and the CCR may carry information regarding a single application request and PCRB 144, 146 may create at least one PCC rule based on the combination of the AAR and the CCR. In various embodiments, PCRB 144, 146 may be capable of handling both single-message and paired-message application requests.

Upon creating a new PCC rule or upon request by the PGW 134, PCRB 144, 146 may provide a PCC rule to PGW 134 via the Gx interface. In various embodiments, such as those implementing the proxy mobile IP (PMIP) standard for example, PCRB 144, 146 may also generate QoS rules. Upon creating a new QoS rule or upon request by the SGW 132, PCRB 144, 146 may provide a QoS rule to SGW 132 via the Gxx interface.

Subscriber profile repository (SPR) 148 may be a device that stores information related to subscribers to the subscriber network 100. Thus, SPR 148 may include a machine-readable storage medium such as read-only memory (ROM), random-access memory (RAM), magnetic disk storage media, optical storage media, flash-memory devices, and/or similar storage media. SPR 148 may be a component of one of PCRB 144, 146 or may constitute an independent node within EPC 130 or session control device 140. Data stored by SPR 148 may include subscriber information such as identifiers for each subscriber, bandwidth limits, charging parameters, and subscriber priority.

Packet data network 160 may be any network for providing data communications between user equipment 110 and other devices connected to packet data network 160. Packet data network 160 may further provide, for example, phone or Internet service to various user devices in communication with packet data network 160.

The OCS's 150, 152 may each be a device that meters subscriber usage of the carrier network and charges an account of the subscriber accordingly. For example, an OCS 150, 152, following a metric provided by one of the PCRBs 144, 146 may monitor data transfer and charge a monetary account, minutes account, data transfer account, or other appropriate account. As shown, various embodiments may include two or more OCS's 150, 152 to expand the number of subscribers that may be supported. In some situations, a PCRB 144, 146 may attempt to establish a charging session via the Gy Diameter application but receive a rejection, error, or no response from the OCS 150 (e.g., the OCS 150 may be temporarily down or at capacity). Upon receiving the unsatisfactory response, the PCRB 144, 146 may resend the request to another OCS 152 in search of a satisfactory result. According to various embodiments, the DRA 142 may not forward the unsatisfactory response to the PCRB 144, 146 and, instead, resend the original request to a different OCS 152 itself based on internally configured rules, thereby alleviating the need for the PCRB 144, 146 to handle the response. It will be apparent in view of the description below that such functionality may also be used in other contexts such as, for example, a PCRB 144, 146 rejecting an establishment request from a PGW 134.

As will be understood, various Diameter applications may be established within subscriber network 100 and supported by DRA 142. For example, an Rx application may be established between an AF (not shown) and each of PCRBs 144, 146. As another example, an Sp application may be established between SPR 148 and each of PCRBs 144, 146. As yet another example, an S9 application may be established between one or more of PCRBs 144, 146 and a remote device implementing another PCRF (not shown). As will be understood, numerous other Diameter applications may be established within subscriber network 100.

In supporting the various potential Diameter applications, DRA 142 may receive Diameter messages, process the messages, and perform actions based on the processing. For example, DRA 142 may receive a Gx CCR from PGW 134, identify an appropriate PCRB 144, 146 to process the Gx CCR, and forward the Gx CCR to the identified PCRB 144, 146. DRA 142 may also act as a proxy by modifying the subsequent Gx CCA sent by the PCRB 144, 146 to carry an origin-host identification pointing to the DRA 142 instead of the PCRB 144, 146. Additionally or alternatively, DRA 142 may act as a redirect agent or otherwise respond directly to a request message by forming an appropriate answer message and transmitting the answer message to an appropriate requesting device.

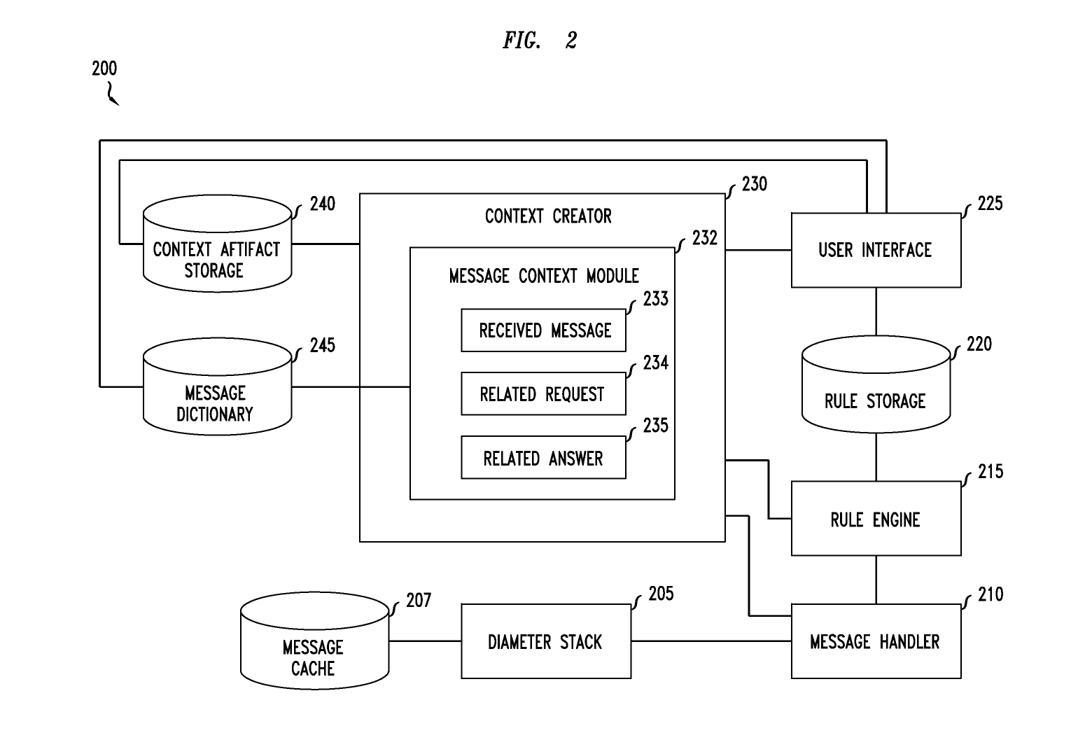

FIG. 2 illustrates an exemplary Diameter Routing Agent (DRA) 200. DRA 200 may be a standalone device or a component of another system. For example, DRA 200 may correspond to DRA 142 of exemplary environment 100. In such an embodiment, DRA 142 may support various Diameter applications defined by the 3GPP such as Gx, Gxx, Rx, or Sp. It will be understood that DRA 200 may be deployed in various alternative embodiments wherein additional or alternative applications are supported. As such, it will be apparent that the methods and systems described herein may be generally applicable to supporting any Diameter applications.

DRA 200 may include a number of components such as Diameter stack 205, message cache 207, message handler 210, rule engine 215, rule storage 220, user interface 225, context creator 230, context artifact storage 240, and message dictionary 245.

Diameter stack 205 may include hardware or executable instructions on a machine-readable storage medium configured to exchange messages with other devices according to the Diameter protocol. Diameter stack 205 may include an interface including hardware or executable instructions encoded on a machine-readable storage medium configured to communicate with other devices. For example, Diameter stack 205 may include an Ethernet or TCP/IP interface. In various embodiments, Diameter stack 205 may include multiple physical ports.

Diameter stack 205 may also be configured to read and construct messages according to the Diameter protocol. For example, Diameter stack may be configured to read and construct CCR, CCA, AAR, AAA, RAR, and RAA messages. Diameter stack 205 may provide an application programmer's interface (API) such that other components of DRA 200 may invoke functionality of Diameter stack. For example, rule engine 215 may be able to utilize the API to read an attribute-value pair (AVP) from a received CCR or to modify an AVP of a new CCA. Various additional functionalities will be apparent from the following description.

The Diameter stack 205 stores copies of previously received or processed messages in the message cache 207. For example, upon forwarding a request message, the Diameter stack 205 stores the request message in the message cache 207 for later retrieval. Later, upon receiving an answer message, the Diameter stack 205 may locate the corresponding and previously-stored request message within the message cache 207, such that the two related messages may be considered together.

Message handler 210 may include hardware or executable instructions on a machine-readable storage medium configured to interpret received messages and invoke rule engine 215 as appropriate. In various embodiments, message handler 210 may extract a message type from a message received by Diameter stack 205 and invoke the rule engine using a rule set that is appropriate for the extracted message type. For example, the message type may be defined by the application and command of the received message. After evaluating one or more rules, rule engine 215 may pass back an action to be taken or a message to be sent. Message handler 210 may then transmit one or more messages via Diameter stack 205, as indicated by the rule engine 215.

Rule engine 215 may include hardware or executable instructions on a machine-readable storage medium configured to process a received message by evaluating one or more rules stored in rule storage 220. As such, rule engine 215 may be a type of processing engine. Rule engine 215 may retrieve one or more rules, evaluate criteria of the rules to determine whether the rules are applicable, and specify one or more result of any applicable rules. For example, rule engine 215 may determine that a rule is applicable when a received Gx CCR includes a destination-host AVP identifying DRA 200. The rule may specify that the destination-host AVP should be changed to identify a PCRB before the message is forwarded.

Rule storage 220 may be any machine-readable medium capable of storing one or more rules for evaluation by rule engine 215. Accordingly, rule storage 220 may include a machine-readable storage medium such as read-only memory (ROM), random-access memory (RAM), magnetic disk storage media, optical storage media, flash-memory devices, and/or similar storage media. In various embodiments, rule storage 220 may store one or more rule sets as a binary decision tree data structure. Various other data structures for storing a rule set will be apparent.

It will be understood that, while various components are described as being configured to perform functions such as evaluating rules or accessing context objects based on rules, such configurations may not require any rules to be present in rule storage. For example, rule engine 215 may be configured to evaluate a rule including a context object reference even if no such rule is stored in rule storage 220. Thereafter, if a user adds such a rule to rule storage, rule engine 215 may process the rule as described herein. In other words, as used herein, the phrase “configured to” when used with respect to functionality related to rules will be understood to mean that the component is capable of performing the functionality as appropriate, regardless of whether a rule that requests such functionality is actually present.

User interface 225 may include hardware or executable instructions on a machine-readable storage medium configured to enable communication with a user. As such, user interface 225 may include a network interface (such as a network interface included in Diameter stack 205), a monitor, a keyboard, a mouse, or a touch-sensitive display. User interface 225 may also provide a graphical user interface (GUI) for facilitating user interaction. User interface 225 may enable a user to customize the behavior of DRA 200. For example, user interface 225 may enable a user to define rules for storage in rule storage 220 and evaluation by rule engine 215. Various additional methods for a user to customize the behavior of DRA 200 via user interface 225 will be apparent to those of skill in the art.

According to various embodiments, rule storage 220 may include rules that reference one or more “contexts” or “context objects.” In such embodiments, context creator 230 may include hardware or executable instructions on a machine-readable storage medium configured to instantiate context objects and provide context object metadata to requesting components. Context objects may be instantiated at run time by context creator 230 and may include attributes or actions useful for supporting the rule engine 215 and enabling the user to define complex rules via user interface 225. For example, context creator 230 may provide context objects representing various Diameter messages.

Upon DRA 200 receiving a Diameter message to be processed, message handler 210 may send an indication to context creator 230 that the appropriate context objects are to be instantiated. Context creator 230 may then instantiate such context objects. In some embodiments, context creator 230 may instantiate all known context objects or may only instantiate those context objects actually used by the rule set to be applied by rule storage 220. In other embodiments, context creator 230 may not instantiate a context object until it is actually requested by the rule engine 215.

Context creator 230 may additionally facilitate rule creation by providing context metadata to user interface 225. In various embodiments, context creator 230 may indicate to user interface 225 which context objects may be available for a rule set being modified and what attributes or actions each context object may possess. Using this information, user interface 225 may present a point-and-click interface for creating complex rules. For example, user interface 225 may enable the user to select a desired attribute or action of a context object from a list for inclusion in a rule under construction or modification.

Context creator 230 may rely on one or more context artifacts stored in context artifact storage 240 in establishing context objects. As such, context artifact storage 240 may be any machine-readable medium capable of storing one or more context artifacts. Accordingly, context artifact storage 240 may include a machine-readable storage medium such as read-only memory (ROM), random-access memory (RAM), magnetic disk storage media, optical storage media, flash-memory devices, and/or similar storage media. Context artifact storage 240 may store artifacts in various forms such as, for example, run-time libraries. In various embodiments, such run-time libraries may be stored as Java archive (.jar) files.

Each context artifact may define the attributes or actions available for a context object. In various embodiments, the context artifact may define one or more functions to be executed when an attribute or action is accessed. Such functions may utilize other functionality of the DRA 200, such as accessing the API of the Diameter stack, or may return values to the component that called the attribute or action. The context artifact may also include tags or other metadata for context creator 230 to provide to user interface 225 for describing the actions and attributes of the context object. In exemplary DRA 200, context artifact storage 240 may store context artifacts defining a message context, a routing decision context, or a subscriber record context. These context artifacts may be used by context creator 230 at run-time to instantiate different types of context objects. As such, context creator 230 may be viewed as including a message context module 232. In various embodiments, a user may be able to define new context artifacts via user interface 225 for storage in context artifact storage, such as by specifying an existing file (e.g. a .jar file).

Message context module 232 may represent the ability of context creator 230 to generate context objects representing and providing access to Diameter messages. For example, message context module 232 may generate a context object representing the received message. In various embodiments, message context module 232 may also be configured to generate a context object representing a request message or an answer message associated with the received Diameter message, as appropriate. As such, message context module 232 may be viewed as including a received message submodule 233, a related request submodule 234, and a related answer submodule 235.

The contents of Diameter messages may vary depending on the application and command type. For example, an RX RAA message may include different data from a GX CCR message. Such differences may be defined by various standards governing the relevant Diameter applications. Further, some vendors may include proprietary or otherwise non-standard definitions of various messages. Message context module 232 may rely on message definitions stored in message dictionary 245 to generate message contexts for different types of Diameter messages. For example, upon receiving a Diameter message, message handler 210 may pass the application and command type to the context creator 230. Message context module 232 may then locate a matching definition in message dictionary 245. This definition may indicate the AVPs that may be present in a message of the specified type. Message context module 232 may then instantiate a message context object having attributes and actions that match the AVPs identified in the message definition.

Message dictionary 245 may be any machine-readable medium capable of storing one or more context artifacts. Accordingly, message dictionary 245 may include a machine-readable storage medium such as read-only memory (ROM), random-access memory (RAM), magnetic disk storage media, optical storage media, flash-memory devices, and/or similar storage media. Message dictionary 245 may include various message definitions in appropriate forms such as, for example, extensible markup language (XML) files. Message dictionary 245 may include a number of predefined definitions included with the DRA 200 by a supplier. In various embodiments, a user may be able to provide new, user-defined message definitions via user interface 225. For example, if the user wishes to support an application not already defined by the predefined definitions, the user may generate or otherwise obtain a definition file for storage in message dictionary 245. In various embodiments, the user-defined definitions may be stored in a different portion of message dictionary 245, such as a different directory, from the predefined definitions.

In various embodiments, the user may also be able to extend predefined definitions via user interface 225. The user may be able to provide extension definitions that define new AVPs or specify additional AVPs to occur in a particular message type. For example, a user may wish to support a proprietary AVP within an Rx AAR. To provide such support, the user may provide a definition file, such as an XML file, defining the proprietary AVP and indicating that the proprietary AVP may be present in an Rx AAR. Such extension definitions may also be stored in a different area of message dictionary 245 from the predefined definitions. Message context module 232 may be configured to apply any applicable extension definitions when instantiating a new message context object or providing context metadata to user interface 225.

As noted above, upon receiving a Diameter message, message handler 210 may extract the application and command type and pass this information to context creator 230, which then may locate any applicable definitions to instantiate a new received message context object. Received message submodule 233 may be further configured to associate the new context object with the received Diameter message itself. For example, received message submodule 233 may copy the received Diameter message from Diameter stack 205 into a private or protected variable. Alternatively, received message submodule 233 may store an identification of the Diameter message useful in enabling access to the Diameter message via the API of the Diameter stack 205.

In various embodiments, DRA 200 may support the use of inverse message contexts. In such embodiments, upon extracting the command type from the received Diameter message, message handler 210 may identify the inverse message type as well. In some such embodiments, message handler 210 may implement a look-up table identifying the inverse for each message command. For example, upon determining that a received Diameter message is a Gx CCR, the message handler may determine that the inverse message would be a Gx CCA. Message handler 210 may pass this information to context creator 230 as well.

Upon receiving an inverse message type, message context module 232 may instantiate an inverse message context object in a manner similar to that described above with regard to the received message context object. Related request submodule 234 or related answer submodule 235, as appropriate, may also associate the new context object with message data. If the inverse message is a request message, related request module 234 may identify a previously-processed request message stored in Diameter stack 205 and associate the message with the new context object in a manner similar to that described above. In various embodiments, upon receiving an answer message, Diameter stack 205 may locate the previously-processed and forwarded request message to which the answer message corresponds. Diameter stack 205 may present this related request message through the API for use by context creator 230 or other components of DRA 200. By associating the previous request message with the related request context object, rule engine 215 may be provided with attributes capable of accessing the AVPs carried by the request message that prompted transmission of the answer message being processed.

When the inverse message is an answer message, on the other hand, related answer module 235 may construct a new answer message by, for example, requesting, via the API, that Diameter stack 205 construct the answer message. The new answer message may be completely blank or may include at least some values copied over from the received Diameter request message. Related answer module 235 may associate the new context object with the new answer message in a manner similar to that described above with respect to received message module 233. The related answer context object may then provide rule engine 215 with access to various actions capable of modifying the new answer message. For example, the rule engine may utilize an action of the related answer context object to set a result-code AVP of the answer message, thereby indicating to the message handler 210 that the answer should be sent back to the device that sent the received request. Message handler 210 may also then refrain from forwarding the received request message to any other devices.

As noted above, context creator 230 may be capable of defining other context objects that do not represent a Diameter message. Such context objects may be referred to as “computational contexts” and may also be defined by contexts artifacts in context artifact storage 240.

It should be noted that while message cache 207, rule storage 220, context artifact storage 240, and message dictionary 245 are illustrated as separate devices, one or more of these components may be resident on multiple storage devices. Further, one or more of these components may share a storage device. For example, rule storage 220, context artifact storage 240, and message dictionary 245 may all refer to portions of the same hard disk or flash memory device.

FIG. 3 illustrates an exemplary hardware diagram 300 for implementing a Diameter Routing Agent. The hardware device 300 may correspond to, for example, DRA 142 of FIG. 1.

As shown, the device 300 includes a processor 320, memory 330, user interface 340, network interface 350, and storage 360 interconnected via one or more system buses 310. It will be understood that FIG. 3 constitutes, in some respects, an abstraction and that the actual organization of the components of the device 300 may be more complex than illustrated.

The processor 320 may be any hardware device capable of executing instructions stored in the memory 330 or the storage 360. As such, the processor may include a microprocessor, field programmable gate array (FPGA), application-specific integrated circuit (ASIC), or other similar devices.

The memory 330 may include various memories such as, for example L1, L2, or L3 cache or system memory. As such, the memory 330 may include static random access memory (SRAM), dynamic RAM (DRAM), flash memory, read only memory (ROM), or other similar memory devices.

The user interface 340 may include one or more devices for enabling communication with a user such as an administrator. For example, the user interface 340 may include a display, a mouse, and a keyboard for receiving user commands. In some embodiments, the user interface 340 may include a command line interface or graphical user interface that may be presented to a remote terminal via the network interface 350.

The network interface 350 may include one or more devices for enabling communication with other hardware devices. For example, the network interface 350 may include a network interface card (NIC) configured to communicate according to the Ethernet protocol. Additionally, the network interface 350 may implement a TCP/IP stack for communication according to the TCP/IP protocols. Various alternative or additional hardware or configurations for the network interface 350 will be apparent.

The storage 360 may include one or more machine-readable storage media such as read-only memory (ROM), random-access memory (RAM), magnetic disk storage media, optical storage media, flash-memory devices, or similar storage media. In various embodiments, the storage 360 may store instructions for execution by the processor 320 or data upon which the processor 320 may operate.

For example, as shown, the storage 360 includes an operating system 362 to direct the basic operations of the device 300 and a Diameter implementation 364 for performing standard and non-standard operations involved in communicating with other devices according to the Diameter protocol. The Diameter implementation 364 is also allocated an area 334 in memory 330 where previously processed messages 335 may be stored as part of a message cache.

The storage also includes a rules engine 366 that evaluates a plurality of rules 368 at run time. In various embodiments, the rules engine 366 is implemented as a plug-in to the Diameter implementation 364 such that, upon receiving any message, the Diameter implementation 364 invokes the rules engine as part of processing the message. As explained above, the rules 368 may reference actions or attributes carried by context objects. As such, the storage 360 includes context creation instructions 370 that, as appropriate, creates contexts in an area of memory 337 for access by the rules engine 366 upon encountering a context object reference in a rule 368. To support the context creation instructions 370, the storage 360 also includes multiple context artifacts 372 and message definitions 374. For example, upon receiving a Gx CCA message, the context creation instructions 370 may locate a Diameter message context artifact 372 and Gx CCA definition 374 to create a Gx CCA message context 339 in memory 330. Similarly, the context creation instructions 370 may use the Diameter message context artifact 372 and Gx CCR definition 374 to create a Gx CCR message context object 338 in memory 330 to represent the previous CCR message 335 associated with the received CCA.

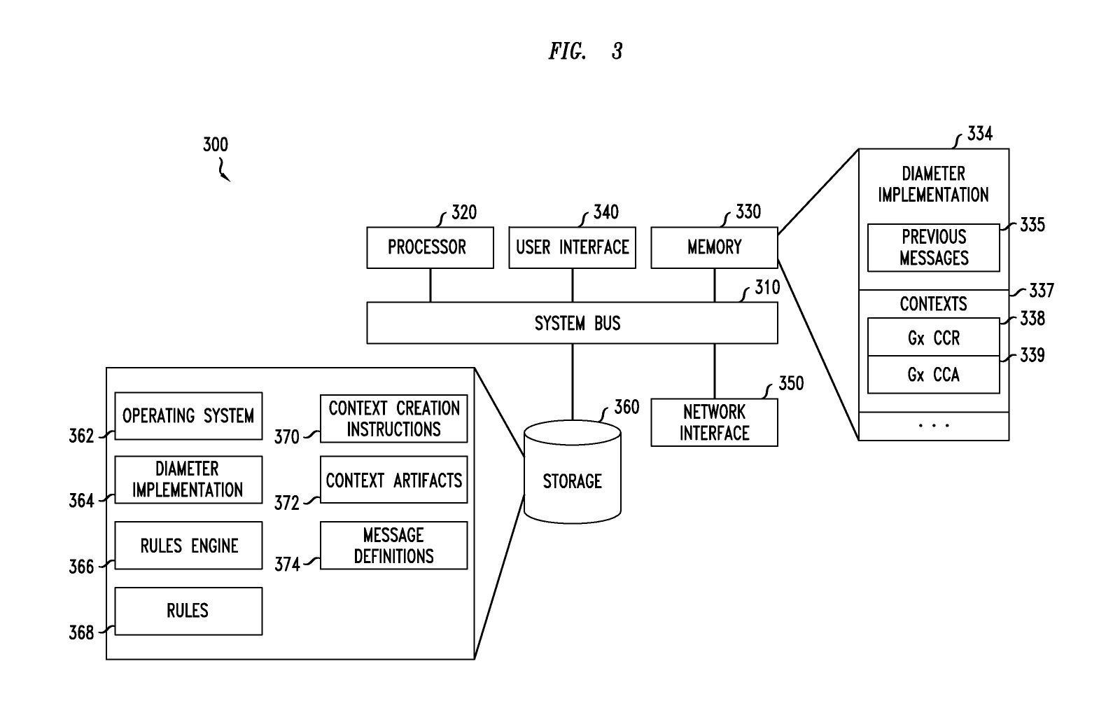

FIG. 4 illustrates an exemplary class diagram 400 for defining various message context objects. The class diagram 400 may illustrate how context objects representing various types of Diameter messages may be created from a single context object base class. As shown, various context classes representing request messages, such as Gx CCR 422 and Rx RAR 424 context objects, may extend a base message context class 410 via an intermediate request class 420. Similarly, various context objects representing response messages, such as Gx CCA 432 and Rx RAA 434 context objects, may extend the base message context class 410 via an intermediate response class 430. Each of the classes in the diagram 400 may provide various attributes and actions that are exposed to the rules engine upon instantiation as an object. For example, the Gx CCR 422, Rx RAR 424, Gx CCA 432, and Rx RAA 434 classes may each define various getters and setters for reading and modifying the contents of the various attribute-value pairs (AVPs) that would be contained in a message of that type. Similarly, the message context class 410 may define functionality that is available to all message context objects regardless of message type such as a “send” action, a getter for a command type, or generic getter and setter methods for AVPs that are extended or otherwise utilized by AVP-specific getters and setters implemented by extending classes.

As shown, the response class 430 includes two methods available to response type Diameter message context objects (e.g., to the Gx CCA class 432 or Rx RAA class 434): a resend request method and a reprocess request method. The resend request method may instruct the Diameter stack to resend the corresponding request message for the response message within which the resend request method is called. For example, if, in processing a Gx CCA, a rule includes the reference “Gx CCA.Resend-Request,” the rule engine would execute the Resend-Request( ) method upon evaluating the reference; at the instruction of the Resend-Request method, the Diameter stack would locate the Gx CCR corresponding to the current Gx CCA and transmit the CCR to its stated destination. Such a method may be useful when, for example, an operator wishes to create rules within the response processing ruleset to resend a request, either to the same device as before or to a different device (e.g., by altering the destination of the response through a reference to the inverse message context object and subsequently calling the Resend-Request method).

The reprocess request method, rather than immediately sending the request as it currently resides in the Diameter stack, invokes the rules engine with respect to the request message. Such invocation may also end execution of a currently running execution of the rules engine with respect to the response message, effectively shifting the rules engine focus from the received response back to the previous request message. In other words, when the rules engine, in evaluating a response rule set for a response message, encounters a reference to the reprocess request method, the rules engine may cease execution of the response rule set and begin execution of a request rule set for the request that is related to the response. Such functionality may be useful, for example, when the request rule set already includes functionality for selecting a destination device.

As will be understood, reprocessing or resending messages to achieve different (more desirable) results may be difficult without some means of persisting state from one execution to the next. For example, if a request sent to node 1 of a node set results in a response message carrying an error code, reprocessing the initial request may result in sending the request back to node 1 if the rule set is unable to tell where the request was previously sent. To provide such state persistence, the message context class 410 includes a set of functions to provide the ability to persist information about a request between executions of the rules engine. Specifically, the methods provide getters and setters for two types of properties: string (e.g. alphanumeric) type properties and long integer (e.g., numeric) type properties. It will be understood that alternative or additional data types may be used (e.g., other integer, floating point, Boolean, character, etc.) or properties may be stored as untyped values.

Each property may be stored via the setter along with an identifying key (which, in the example shown, is a string data type). Thereafter, the getter may locate the property associated with the key. A helper “property-exists” function may also be provided to determine whether a given identifying key has been previously assigned a value. Such a function may be helpful, for example, to avoid calling a getter function for a property that does not yet exist (and potentially causing an error such as an “index out of bounds” exception). In various embodiments, when storing a property, the getters may store the key and value in an area of memory of the DRA set aside as associated with message (e.g., a data structure representing the message) or within the body of the message itself as, for example, an AVP. In embodiments where properties are stored in the Diameter message, the Diameter stack may be modified to send the Diameter message (upon instruction by the rules engine) without any such added properties such that the properties added by the rules engine for internal use are not exposed to other devices.

As an example, an operator may provide a request processing rule set for a Gx CCR including the following rules:

```
. . .
IF Not Gx CCR.Property-Exists(“Times-Processed”)
    Gx CCR.Set-Long-Property(“Times-Processed”, 1)
ELSE
    Gx CCR.Set-Long-Property(“Times-Processed”, 1 + Gx
        CCR.Get-Long-Property(“Times-Processed”))
Gx CCR.Destination-Host.Set(“PCRB-” + Gx
CCR.Get-Long-Property(“Times-Processed”))
. . .
```

In this simple example, the rule set creates a “Times-Processed” property initialized to “1” on the first execution and, on each subsequent execution increments this property. The rules also set the destination of the Gx CCR based on this value. A response ruleset could then, whenever an error response is received, simply call Gx CCA.Reprocess-Request to re-invoke the above rules. Thus, if the DRA receives a Gx CCR from a PGW, it may create a new variable within the Gx CCR data structure to store the “Times-Processed”->“1” property and set the Destination-Host AVP within the Gx CCR to “PCRB-1” (based on the “Times-Processed” property). Later, after the Gx CCR is forwarded to PCRB-1, if PCRB-1 returns a Gx CCA indicating that the request was rejected, the response ruleset re-invokes the request ruleset by calling “Gx CCA.Reprocess-Request( ).” On this execution, the variable corresponding to the “Times-Processed” property is incremented to “2,” and the Destination-Host AVP is set to “PCRB-2,” such that the Diameter stack will transmit the Gx CCR to PCRB-2 instead on this execution.

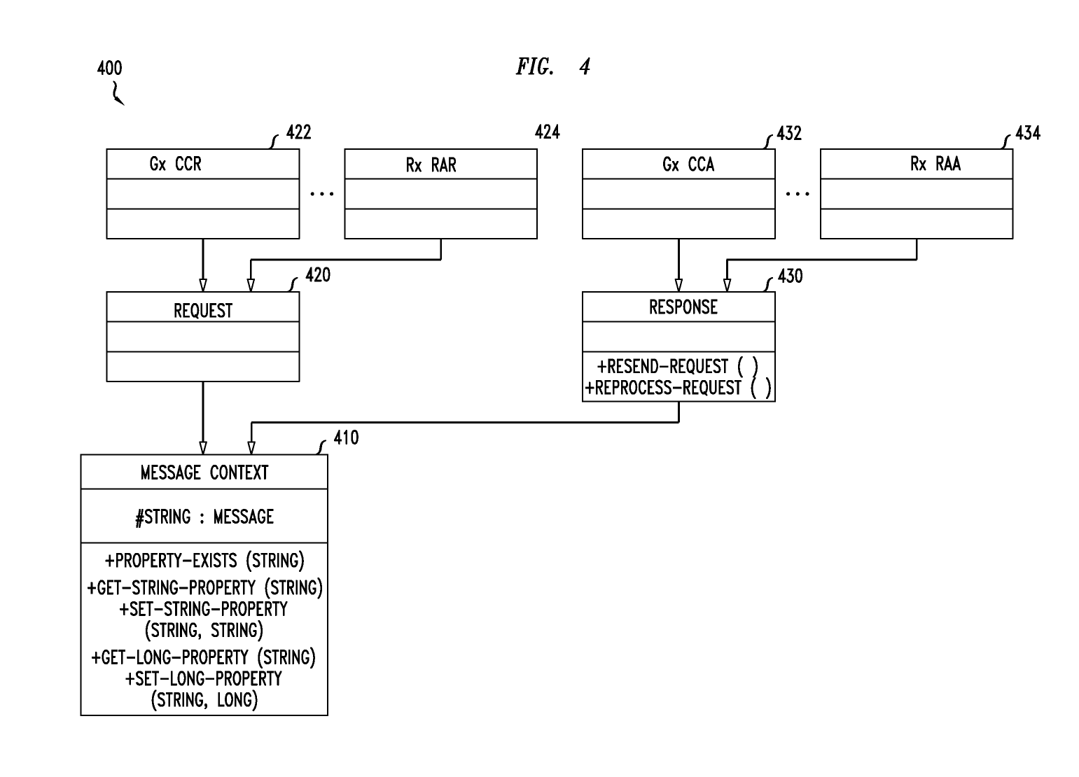

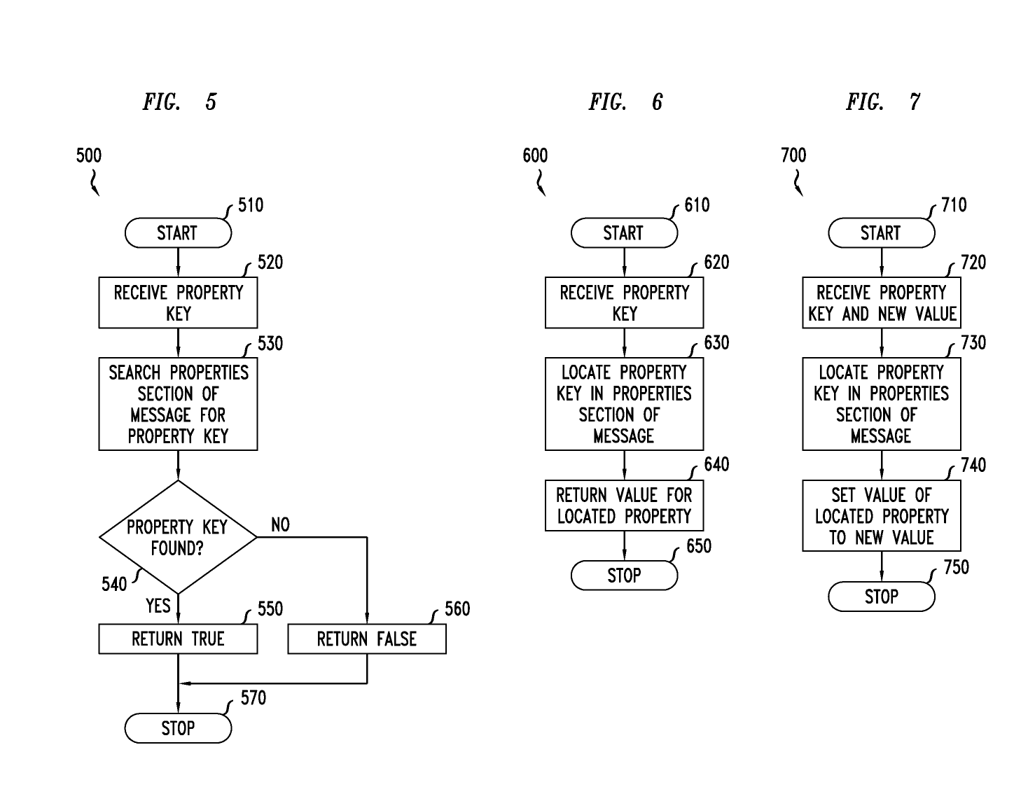

FIG. 5 illustrates an exemplary method 500 for providing a “Property-Exists” function. The method 500 may be performed by a processor such as, for example, processor 320, invoking the “Property-Exists” function of a context object 337 in response to encountering a reference within a rule 368.

The method 500 begins in step 510 and proceeds to step 520 where the processor receives a property key (such as a string value passed in by the rules engine instructions from a rule being evaluated). In step 530, the processor searches the properties section of the message for the property key. For example, in some embodiments, all properties may be stored in a single AVP; in such embodiments the processor may search this AVP for the received key. In some embodiments, each property may be stored in a separate AVP that is denoted as an internal AVP. For example, a “Times-Processed” property may be stored in an AVP having the attribute “INTERNAL-Times-Processed.” In such embodiments, the processor may search all AVPs carrying the “INTERNAL-” prefix (or other prefix or other identifier as an internal AVP) for the received key.

In step 540, the processor determines if the received key was found. If so, the method 500 returns true in step 550. Otherwise, the method 500 returns false in step 560. The method 500 then proceeds to end in step 570.

FIG. 6 illustrates an exemplary method 600 for providing a property getter function. The method 600 may be performed by a processor such as, for example, processor 320, invoking the “Get-Long-Property” or “Get-String-Property” function of a context object 337 in response to encountering a reference within a rule 368.

The method 600 begins in step 610 and proceeds to step 620 where the processor receives a property key (such as a string value passed in by the rules engine instructions from a rule being evaluated). In step 630, the processor searches the properties section of the message for the property key. After locating the AVP (or other data structure) corresponding to the received key, the method 600 returns the associated value to the rule engine in step 640. The method 600 then proceeds to end in step 650. In various embodiments, the method 600 may additionally include a check to make sure the received key exists (e.g., by calling the Property-Exists method 500) before attempting to access it. This might enable the method 600 to “fail gracefully” when a rule provides an input key that does not correlate to an existing property.

FIG. 7 illustrates an exemplary method 700 for providing a property setter function. The method 700 may be performed by a processor such as, for example, processor 320, invoking the “Set-Long-Property” or “Set-String-Property” function of a context object 337 in response to encountering a reference within a rule 368.

The method 700 begins in step 710 and proceeds to step 720 where the processor receives a property key and a new value for the property key (such as pair of values passed in by the rules engine instructions from a rule being evaluated). In step 730, the processor searches the properties section of the message for the property key. If the property key is not found, the processor may create a new AVP or other data structure to correspond to the property key. After locating the AVP (or other data structure) corresponding to the received key, the processor stores the new value in the located AVP in step 740 for later retrieval. The method 700 then proceeds to end in step 750.

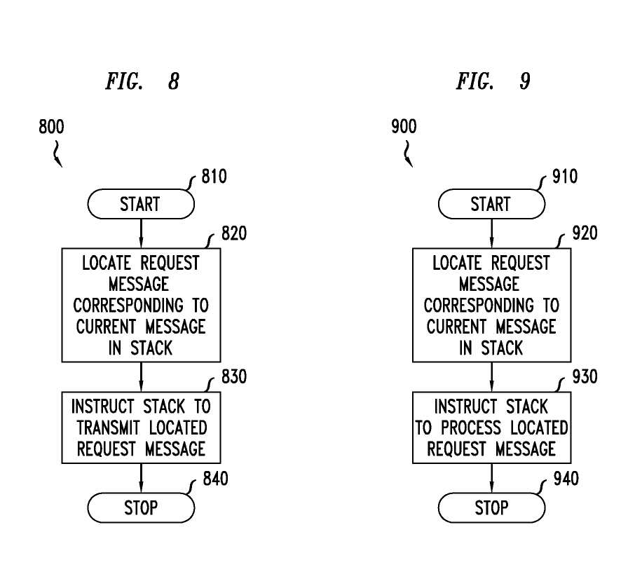

FIG. 8 illustrates an exemplary method 800 for providing a resend function. The method 800 may be performed by a processor such as, for example, processor 320, invoking the “Resend-Request” function of a context object 337 in response to encountering a reference within a rule 368.

The method 800 begins in step 810 and proceeds to step 820 where the processor locates, within the message cache of the Diameter stack, the request message that is associated with the response message from which the method 800 was called. For example, the processor may locate a request message having the same or similar identifying information. Alternatively, the Diameter stack may have already associated the request with the response upon receipt thereof. In such implementations, step 820 may simply involve finding an identifier for the request message. Next, in step 830, the processor instructs the Diameter stack to transmit the request message by, for example, providing the request message identifier along with an API call. The Diameter stack may then proceed to transmit the message according to the address information contained therein. The method 800 then proceeds to end in step 840.

FIG. 9 illustrates an exemplary method 900 for providing a reprocess function. The method 900 may be performed by a processor such as, for example, processor 320, invoking the “Reprocess-Request” function of a context object 337 in response to encountering a reference within a rule 368.

The method 900 begins in step 910 and proceeds to step 920 where the processor locates, within the message cache of the Diameter stack, the request message that is associated with the response message from which the method 900 was called. For example, the processor may locate a request message having the same or similar identifying information. Alternatively, the Diameter stack may have already associated the request with the response upon receipt thereof. In such implementations, step 920 may simply involve finding an identifier for the request message. Next, in step 930, the processor instructs the Diameter stack to process the request message. For example, the Diameter stack may traverse a set of Java proxylets and other plugins (including, for example, a rules engine), as would normally be processed upon initially receiving a request. In various contexts, the Diameter stack may transmit the message to its stated destination after traversing the proxylets and plugins. The method then proceeds to end in step 940. Thereafter, outside of method 900, the processor would evaluate the rules sets corresponding to the request message according to the rules engine instructions.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A non-transitory machine-readable storage medium encoded with instructions for execution by a network device, the non-transitory machine-readable storage medium comprising:
instructions for associating a received response message with a previously-processed request message;
instructions for evaluating operator-defined rules at run-time with respect to the received response message, the instructions for evaluating comprising:
instructions for processing the previously-processed request as an outgoing request in response to encountering a first reference in an operator-defined rule.

2. The non-transitory machine-readable storage medium of claim 1, wherein the first reference indicates that the previously-processed request should be retransmitted, and the instructions for processing the previously-processed request as an outgoing request comprise instructions for transmitting the previously-processed request to another device based on a current destination address of the previously-processed request.

3. The non-transitory machine-readable storage medium of claim 1, wherein the first reference indicates that the previously-processed request should be reprocessed, and the instructions for processing the previously-processed request as an outgoing request comprise instructions for invoking an evaluation of at least one operator defined rule with respect to the previously-processed request.

4. The non-transitory machine-readable storage medium of claim 1, wherein the instructions for evaluating operator-defined rules at run-time with respect to the received response message comprise instructions for modifying the contents of the previously-processed request message in response to encountering a second reference in an operator-defined rule.

5. The non-transitory machine-readable storage medium of claim 1, further comprising instructions for evaluating operator-defined rules at run-time with respect to received request messages comprising:
instructions for storing a value in association with the received request message in response to encountering a second reference in an operator-defined rule, whereby the instructions for associating a received response message with a previously-processed request message also retrieve values previously associated with the previously-processed request message.

6. The non-transitory machine-readable storage medium of claim 5, wherein the instructions for storing a value in association with the received request message in response to encountering a second reference in an operator-defined rule comprise instructions for inserting the value into the received request message.

7. The non-transitory machine-readable storage medium of claim 6, further comprising:
instructions for transmitting a received request message to at least one other device and without at least one value inserted into the received request by the instructions for inserting the value into the received request message.

8. A network device comprising:
a network interface;
a memory; and
a processor in communication with the network interface and the memory, the processor being configured to:
associate a received response message with a previously-processed request message;
evaluate operator-defined rules at run-time with respect to the received response message, comprising:
processing the previously-processed request as an outgoing request in response to encountering a first reference in an operator-defined rule.

9. The network device of claim 8, wherein the first reference indicates that the previously-processed request should be retransmitted, and, in processing the previously-processed request as an outgoing request, the processor is configured to transmit the previously-processed request to another device based on a current destination address of the previously-processed request.

10. The network device of claim 8, wherein the first reference indicates that the previously-processed request should be reprocessed, and in processing the previously-processed request as an outgoing request, the processor is configured to invoke an evaluation of at least one operator defined rule with respect to the previously-processed request.

11. The network device of claim 8, wherein, in evaluating operator-defined rules at run-time with respect to the received response message, the processor is configured to modify the contents of the previously-processed request message in response to encountering a second reference in an operator-defined rule.

12. The network device of claim 8, wherein the processor is further configured to evaluate operator-defined rules at run-time with respect to received request messages comprising:
storing a value in association with the received request message in response to encountering a second reference in an operator-defined rule, whereby the instructions for associating a received response message with a previously-processed request message also retrieve values previously associated with the previously-processed request message.

13. The network device of claim 12, wherein, in storing a value in association with the received request message in response to encountering a second reference in an operator-defined rule, the processor is configured to insert the value into the received request message.

14. The network device of claim 13, wherein the processor is further configured to:
transmit a received request message to at least one other device and without at least one value inserted into the received request by the instructions for inserting the value into the received request message.

15. A method performed by a network device, the method comprising:
receiving a response message;
associating the response message with a previously-processed request message;
evaluating at least one operator-defined response rule with respect to the received response message; and
transmitting the previously-processed request message to another network device in response to encountering a first reference within the at least one operator-defined response rule.

16. The method of claim 15, further comprising, prior to transmitting the previously-processed request message, evaluating at least one operator-defined request rule with respect to the previously-processed request message in response to encountering the first reference within the at least one operator-defined response rule.

17. The method of claim 15, further comprising, prior to transmitting the previously-processed request message, modifying the contents of the previously-processed request message in response to encountering a second reference in the at least one operator-defined response rule.

18. The method of claim 15, further comprising, prior to receiving the response message:
evaluating at least one operator-defined request rule at run-time with respect to the previously-processed request message, comprising:
storing a value in association with the previously-processed request message in response to encountering a second reference in an operator-defined request rule,
wherein the step of associating the response message with a previously-processed request message comprises retrieving the value associated with the previously-processed request message.

19. The method of claim 18, wherein storing a value in association with the previously-processed request message comprises inserting the value into the previously-processed request message.

20. The method of claim 19, further comprising, prior to receiving the response message and after inserting the value into the previously-processed request message, transmitting the previously-processed request message without the value inserted into the previously-processed request message.
